(19) United States
(12) Patent Application Publication
(10) Pub. No.: US 2025/0369556 A1
(43) Pub. Date: Dec. 4, 2025

(54) DISPLAY MOUNTING STAND AND DISPLAY DEVICE INCLUDING THE SAME

(71) Applicant: AmTRAN Technology Co., Ltd., New Taipei City (TW)

(72) Inventors: Jun-Hong LIN, New Taipei City (TW); Hung-Tse WANG, New Taipei City (TW); Chun-Ping TAI, New Taipei City (TW); Jie-Min HUANG, New Taipei City (TW)

(21) Appl. No.: 18/977,950

(22) Filed: Dec. 12, 2024

(30) Foreign Application Priority Data
May 30, 2024 (TW) 113120093

(51) Int. Cl. F16M 11/10; F16M 11/18

(52) U.S. Cl. CPC F16M 11/10; F16M 11/18

(57) ABSTRACT

A display mounting stand includes a support base, a rotation mechanism disposed on the support base, and a mounting bracket connected to the rotation mechanism. The rotation mechanism includes a shaft, a rotation connector, a spring device and a spring fixture. The shaft is rotatably disposed on the support base and is connected to the mounting bracket. The rotation connector is fixed to the shaft and includes a connecting structure spaced apart from the shaft. Two ends of the spring device spring device are connected to the connecting structure and the spring fixture, respectively. The spring device is configured to apply a first torque to the shaft. The mounting bracket is configured to apply a second torque, which is caused by a display mounted thereon, to the shaft. The first torque and the second torque are in opposite directions.

### RELATED APPLICATIONS

This application claims priority to Taiwan Application Serial Number 113120093, filed May 30, 2024, the disclosure of which is incorporated herein by reference in its entirety.

### BACKGROUND

### Technical Field

The present disclosure relates to a display mounting stand and a display device including the same.

### Description of Related Art

The display mounting stands currently on the market are designed for small or medium-sized displays and usually only allow the display attached thereto to tilt to adjust the elevation angle of the display or pivot to change the orientation of the display from landscape to portrait. Such designs would not work for large displays with heavy weight. When multiple users are discussing around a large display, it might be necessary to flip the large display to the other side, so that the users from different directions can see the screen. However, conventional designs of display mounting stands cannot meet the requirement of allowing users to easily and quickly flip a large display.

### SUMMARY

In view of the foregoing, one of the objects of the present disclosure is to provide a display mounting stand allowing the display to be flipped.

To achieve the objective stated above, in accordance with an embodiment of the present disclosure, a display mounting stand includes a support base, at least one rotation mechanism disposed on at least one side of the support base, and a mounting bracket pivotably connected to the support base. The rotation mechanism includes a shaft, a rotation connector, at least one spring device and a spring fixture. The shaft is rotatably disposed on the support base and is connected to the mounting bracket. The rotation connector is fixed to the shaft and is configured to rotate with the shaft. The rotation connector includes at least one connecting structure spaced apart from the shaft. The spring device has a first end and a second end opposite to the first end. The first end is connected to the connecting structure of the rotation connector. The spring fixture connects and fixes the second end of the spring device. The mounting bracket is configured to mount a display. The shaft rotates with the mounting bracket. The spring device is configured to apply a first torque to the shaft. The mounting bracket is configured to apply a second torque, which is caused by weight of the display, to the shaft. The first torque and the second torque are in opposite directions.

In one or more embodiments of the present disclosure, the first end of the spring device is pivotably connected to the connecting structure of the rotation connector.

In one or more embodiments of the present disclosure, the rotation connector includes at least one connector disk. The connector disk has a central opening and an outer perimeter. The shaft extends through the central opening. The outer perimeter surrounds the central opening. The connecting structure is positioned between the central opening and the outer perimeter.

In one or more embodiments of the present disclosure, the rotation connector includes a plurality of connector disks arranged in a row and a linkage rod linking the connector disks. The spring device is pivotably connected to the linkage rod.

In one or more embodiments of the present disclosure, the spring device includes a mechanical spring and an interconnection member. The interconnection member includes a section between the mechanical spring and the rotation connector. The section of the interconnection member has a first width, and the mechanical spring has a second width greater than the first width.

In one or more embodiments of the present disclosure, lever arms of the first torque and the second torque are zero when the display mounted on the mounting bracket is rotated to a horizontal orientation.

In one or more embodiments of the present disclosure, the mounting bracket includes a bracket body and a connection portion. The connection portion connects the bracket body to an end of the shaft on the at least one side of the support base.

In one or more embodiments of the present disclosure, the spring device includes a tension spring, and the display mounted on the mounting bracket and the connecting structure of the rotation connector are located on opposite sides of the shaft.

In one or more embodiments of the present disclosure, the spring device includes a compression spring, and the display mounted on the mounting bracket and the connecting structure of the rotation connector are located on same side of the shaft.

In one or more embodiments of the present disclosure, the spring device further includes an interconnection member. The interconnection member includes a rod and a first cap. The first cap is fixedly disposed on the rod and divides the rod into a first section and a second section. The first section penetrates through the compression spring. The second section is connected to the connecting structure of the rotation connector. The compression spring is compressed between the first cap and the spring fixture.

In one or more embodiments of the present disclosure, the spring fixture includes a second cap having a through hole. The second cap presses against a lower end of the compression spring. A lower end of the rod moveably penetrates the through hole of the second cap.

In one or more embodiments of the present disclosure, the display mounting stand further includes a rotation resistance device connected to the shaft. The rotation resistance device is configured to provide a frictional torque to impede rotation of the shaft.

In one or more embodiments of the present disclosure, the spring fixture includes a movable component. The spring device is connected to the movable component, and a length the spring device changes as a position of the movable component is adjusted.

In accordance with an embodiment of the present disclosure, a display device includes the aforementioned display mounting stand and a display mounted on the mounting bracket of the display mounting stand.

In summary, the display mounting stand of the present disclosure includes a rotation mechanism, which includes a shaft, a rotation connector and a spring device. The rotation connector is fixed to the shaft and is configured to rotate with the shaft. Moreover, the rotation connector includes a connecting structure spaced apart from the shaft. The spring device is connected to the connecting structure of the rotation connector and thus can apply torque to the shaft. The mounting stand further includes a mounting bracket connected to the shaft and configured to support a display. By this arrangement, when the mounting bracket and the display are flipped, the spring device applies torque to the rotation connector and the shaft to guide the rotation of the mounting bracket and the display. And as the orientation of the mounting bracket and the display changes, the torque applied by the spring device changes its direction and magnitude, which allows the user to easily flip the display. In addition, once the user stops applying force to the display, the display can automatically decelerate as it rotates downward, or can stop and remain at any angle.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates a perspective view of a display device in accordance with an embodiment of the present disclosure;

FIG. 2 illustrates a front view of the rotation mechanism of the display mounting stand shown in FIG. 1;

FIG. 3 illustrates an exploded view of the rotation mechanism and the mounting bracket shown in FIG. 2;

FIG. 4 illustrates a cross-sectional view of the display device shown in FIG. 1;

FIG. 5 is a schematic diagram illustrating a process of the mounting bracket and the display shown in FIG. 4 being flipped from a first side of the support base to a second side of the support base;

FIG. 6 illustrates an exploded view of some components of the rotation mechanism shown in FIG. 2;

FIG. 7 illustrates a front view of a display mounting stand in accordance with another embodiment of the present disclosure; and

FIG. 8 illustrates section views of a display device in accordance with another embodiment of the present disclosure, and schematically shows a process of the mounting bracket and the display of the display device being flipped from a first side of the base to a second side of the base.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

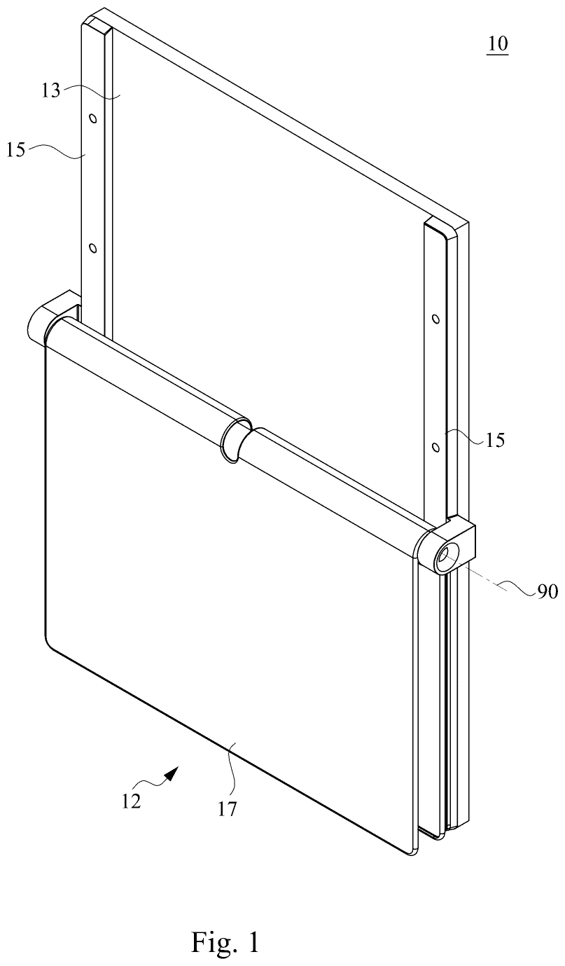

Reference is made to FIG. 1. FIG. 1 illustrates a perspective view of a display device 10 in accordance with an embodiment of the present disclosure. The display device 10 includes a display mounting stand 12 and a display 13 mounted on the display mounting stand 12. The display 13 may be an LCD display, an OLED display, or other types of displays. The display 13 may be provided with human-computer interaction functions, such as touch input, gesture recognition, voice recognition or others. The display mounting stand 12 is a flip-type stand that allows the display 13 attached thereto to be flipped, e.g. 180 degrees from front to back or vice versa.

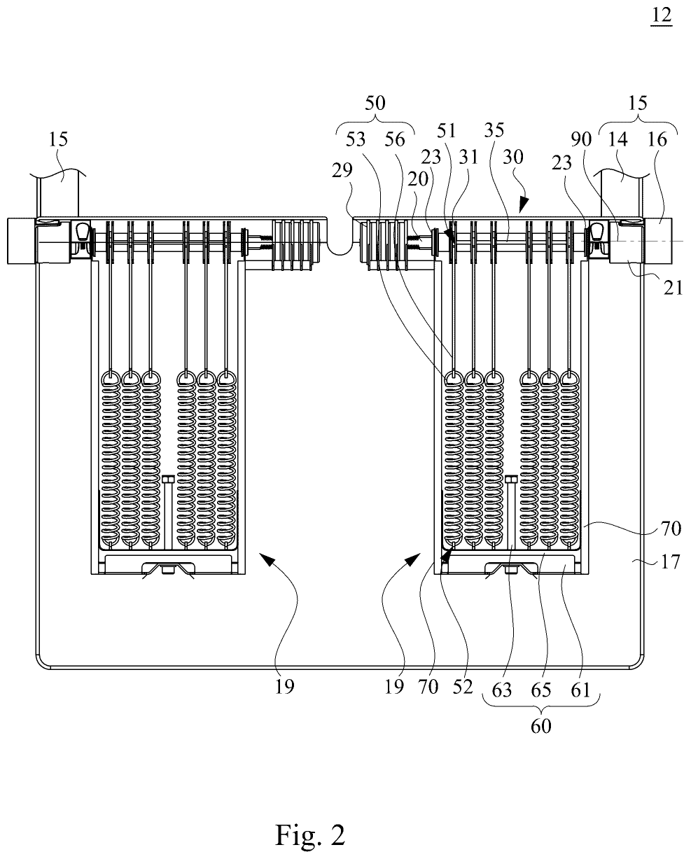

As shown in FIG. 1, the display mounting stand 12 includes a support base 17 and at least one mounting bracket 15. The mounting bracket 15 is pivotally disposed on the support base 17 and is configured to support the display 13. The mounting bracket 15 may rotate relative to the support base 17 about an axis 90, wherein the axis 90 extends generally horizontally from the left side to the right side of the display mounting stand 12. The display 13 may be mounted on the mounting bracket 15 by screwing or other suitable means, such that the display 13 can rotate with the mounting bracket 15 and would not loosen and fall off. The display 13 has a front side and a back side opposite to the front side. The front side of the display 13 has a display screen. The back side of the display 13 faces the mounting bracket 15. The display mounting stand 12 further includes at least one rotation mechanism 19 (see FIG. 2) disposed on at least one side of the support base 17. By virtue of the rotation mechanism 19, the mounting bracket 15 and the display 13 can be flipped from one side of the support base 17 to the other side of the support base 17.

The support base 17 of the display mounting stand 12 in the present disclosure can be statically placed on the floor or on a surface of an object. Alternatively, the support base 17 may be coupled to a moving mechanism such as caster wheels, which allows the display 13 to move with the display mounting stand 12.

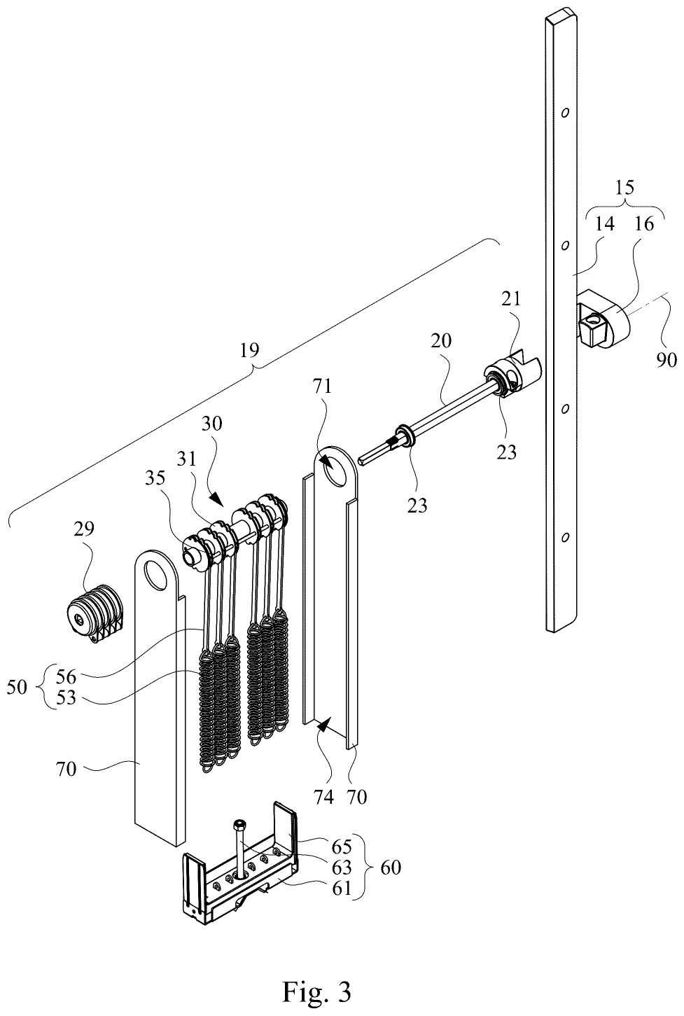

Reference is made to FIGS. 2 and 3. FIG. 2 illustrates a front view of the rotation mechanism 19 of the display mounting stand 12 shown in FIG. 1. FIG. 3 illustrates an exploded view of the rotation mechanism 19 and the mounting bracket 15 shown in FIG. 2. In some embodiments, the display mounting stand 12 includes two rotation mechanisms 19 disposed on the left side and the right side of the support base 17, respectively, and each of the two rotation mechanisms 19 is connected to one of the two mounting brackets 15. However, the present disclosure is not limited thereto. The quantity and position of the at least one rotation mechanism 19 and the at least one mounting bracket 15 can be adjusted as needed. Each rotation mechanism 19 includes a shaft 20 rotatably disposed on the support base 17. The shaft 20 extends along the axis 90 to the left side or the right side of the support base 17 and connects the mounting bracket 15. The shaft 20 is configured to rotate about the axis 90, which allows the mounting bracket 15 connected to the shaft 20 to rotate in conjunction with the shaft 20.

As shown in FIGS. 2 and 3, in some embodiments, each mounting bracket 15 includes a bracket body 14 and a connection portion 16. The connection portion 16 can be disposed at the middle of the bracket body 14 and connect the bracket body 14 to an end of the shaft 20 on one side of the support base 17. The bracket body 14 extends from the connection portion 16 in two opposite directions. The shaft 20 includes a joint structure 21 disposed on an end of the shaft 20 and can be securely assembled with the connection portion 16 of the mounting bracket 15 by screwing or other suitable means.

As shown in FIGS. 2 and 3, in some embodiments, each rotation mechanism 19 further includes a rotation connector 30. The rotation connector 30 is fixed on the shaft 20 and is configured to rotate with the shaft 20. In some embodiments, the rotation connector 30 includes at least one connector disk 31 securely sleeved on the shaft 20. In other words, the shaft 20 extends through the connector disk 31. In some embodiments, the connector disk 31 can be round disk-shaped, or have other suitable shapes.

As shown in FIGS. 2 and 3, the rotation connector 30 includes at least one connecting structure 35. The connecting structure 35 is disposed on the connector disk 31 and is spaced apart from the shaft 20. In some embodiments, when the connector disk 31 is rotating, the connecting structure 35 keeps a constant and positive distance to the shaft 20 and the axis 90. In some embodiments, the connecting structure 35 may be a structure that is assembled with, screwed to, or integrally formed with the connector disk 31. In some embodiments, the connecting structure 35 includes a rod extending through multiple connector disks 31. The rod remains parallel to the axis 90 when the connector disks 31 are rotating.

As shown in FIGS. 2 and 3, in some embodiments, each rotation mechanism 19 further includes at least one shaft bearing 23 and at least one support bracket 70. The support bracket 70 is fixed to the support base 17 and has an opening 71. The shaft 20 extends through the opening 71 of the support bracket 70. The shaft bearing 23 is fitted over the shaft 20 and is disposed in the opening 71 of the support bracket 70, such that the shaft 20 can rotate freely in the opening 71 of the support bracket 70. In some embodiments, the rotation mechanism 19 includes two shaft bearings 23 and two support brackets 70. In some embodiments, the shaft bearing 23 can be replaced by other components with similar function, including but not limited to bushing.

As shown in FIGS. 2 and 3, each rotation mechanism 19 further includes at least one spring device 50 and a spring fixture 60. The spring device 50 is disposed on an inner side of the support bracket 70 and extends to the rotation connector 30. The spring device 50 has a first end 51 and a second end 52 opposite to the first end 51. The first end 51 of the spring device 50 is connected to the connecting structure 35 of the rotation connector 30. The spring fixture 60 connects and fixes the second end 52 of the spring device 50. In some embodiments, each spring device 50 includes a mechanical spring 53. The mechanical spring 53 can apply torque to the rotation connector 30 by virtue of its restoring force. The direction of the torque applied by the mechanical spring 53 is opposite to the direction of a torque caused by the weight of the display 13. In some embodiments, the rotation connector 30 and the spring device 50 are disposed between a pair of shaft bearings 23 and a pair of support brackets 70.

By this arrangement, during the rotation of the mounting bracket 15 and the display 13 in FIG. 1, the spring device 50 applies torque to the rotation connector 30 and the shaft 20, which can counteract at least part of the torque caused by the weight of the display 13. This allows the user to more easily flip the display 13 upwards. Moreover, as the mounting bracket 15 and the display 13 pass the highest point during rotation, the direction of the torque applied by the spring device 50 changes and continues to counteract the torque caused by the weight of the display 13. In addition, once the user stops applying force to the display 13, the display 13 will stop rotating or automatically decelerate as it rotates downwards. Accordingly, the display 13 is prevented from being damaged due to fast rotation speed and is protected from collision or detachment from the stand.

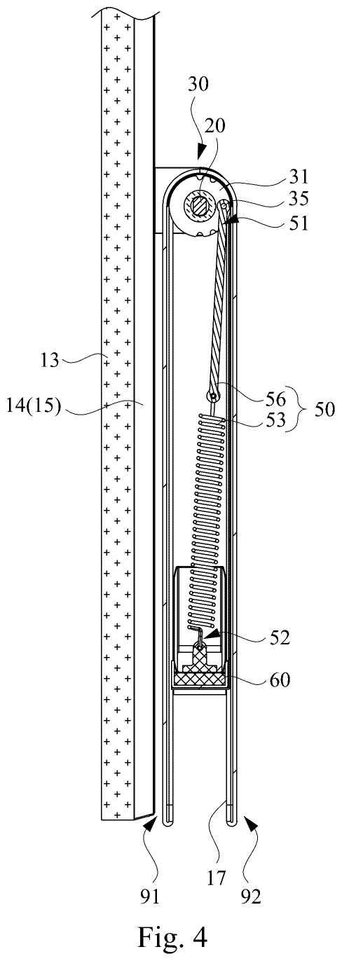

Reference is made to FIG. 4. FIG. 4 illustrates a cross-sectional view of the display device 10 shown in FIG. 1. As shown, the display 13 is mounted on the bracket body 14 of the mounting bracket 15. When the bracket body 14 of the mounting bracket 15 and the display 13 are on a first side 91 of the support base 17, the weight of the display 13 applies a counter-clockwise torque to the shaft 20 through the bracket body 14. On the other hand, the connecting structure 35, which connects the spring device 50 and the connector disk 31, is at a position near a second side 92 of the support base 17. The second side 92 is opposite to the first side 91. In the present embodiment, the mechanical spring 53 of the spring device 50 is a tension spring. The tension spring provides a downward pulling force as the tension spring is stretched. Thus, the spring device 50 can apply a clockwise torque to the shaft 20 through the connecting structure 35 and the connector disk 31. The torque applied by the spring device 50 can partially or completely counteract the torque caused by the weight of the display 13. If the user attempts to rotate the display 13 clockwise from the first side 91 to the second side 92 of the support base 17, the torque provided by the spring device 50 would be in the same direction as the rotation direction of the mounting bracket 15 and the display 13. Thus, the user can more easily flip the display 13 upwards. In cases where the display 13 exceeds eighty inches in screen size, the torque provided by the spring device 50 can significantly reduce the effort required for the user to flip the display 13.

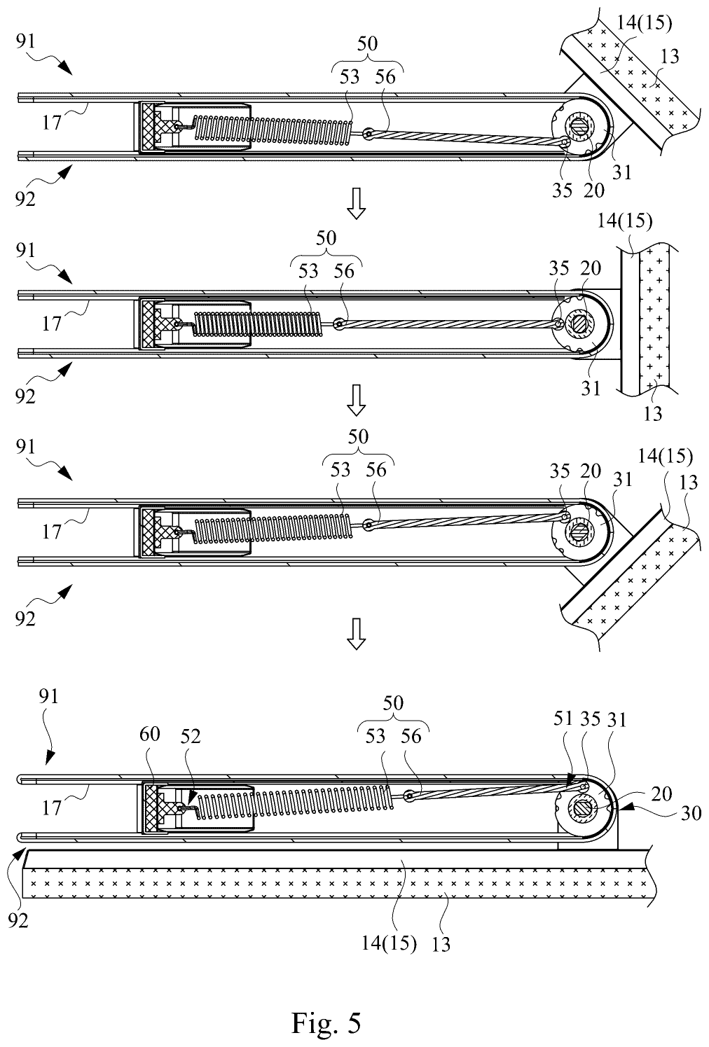

Reference is made to FIG. 5. FIG. 5 is a schematic diagram illustrating a process of the mounting bracket 15 and the display 13 shown in FIG. 4 being flipped from the first side 91 to the second side 92 of the support base 17. During the flipping process, the display 13 and the mounting bracket 15 first rotate upwards in a clockwise direction from the first side 91 to the highest point, i.e., where the orientation of the display 13 and the bracket body 14 of the mounting bracket 15 becomes horizontal, and then the display 13 and the mounting bracket 15 rotate downwards from the highest point to the second side 92. When the display 13 is on the first side 91, the torque caused by the weight of the display 13 is a counterclockwise torque, and the magnitude of the torque gradually decreases as the display 13 is flipped upwards. This is because the position of the connecting structure 35 changes and causes the tension spring to gradually contract and the lever arm to be gradually shortened. When the display 13 reaches the highest point, the torque caused by the weight of the display 13 becomes zero. After passing the highest point, the torque caused by the weight of the display 13 changes to a clockwise direction, and the magnitude of the torque gradually increases as the display 13 rotates downwards. This is because the position of the connecting structure 35 changes and causes the tension spring to be gradually stretched and the lever arm to be gradually lengthened. On the other hand, the connecting structure 35, which is connected to the spring device 50, rotates clockwise from a position near the second side 92 of the support base 17 to a position directly below the shaft 20, and then rotates to a position near the first side 91 of the support base 17. During said process, the torque applied by the spring device 50 to the shaft 20 is initially in the clockwise direction, and the magnitude of the torque gradually decreases as the connecting structure 35 rotates downwards, until the connecting structure 35 reaches its lowest point, i.e., the position directly below the shaft 20, where the magnitude of the torque becomes zero. After the connecting structure 35 rotates and passes the lowest point, the torque applied by the spring device 50 to the shaft 20 changes to the counterclockwise direction, and the magnitude of the torque gradually increases as the connecting structure 35 rotates upwards. Hence, the torque provided by the spring device 50 can constantly counteract the torque caused by the weight of the display 13 during the rotation process, preventing the display 13 from accelerating significantly as the display 13 rotates downwards due to its weight.

In some embodiments, the user is not required manually rotate the display 13 downwards. After the display 13 rotates and passes the highest point, the torque caused by the weight of the display 13 can drive the display 13 to slowly rotate downwards, until the mounting bracket 15 contacts the first side 91 or the second side 92 of the support base 17 and the orientation of the display 13 becomes vertical. In some embodiments, the user may be required to apply force to rotate the display 13 downwards, and the display 13 eventually stops rotation and remains at any angle where the user stops applying force. The display 13 will not rotate downwards due to gravity.

In some embodiments, the spring device 50 is configured to apply a first torque to the shaft 20, while the mounting bracket 15 is configured to apply a second torque to the shaft 20, and the first torque and the second torque are in opposite directions. For example, as shown in FIG. 4, the mounting bracket 15 and the display 13 are located on the first side 91 of the support base 17. The first torque provided by the spring device 50 to the shaft 20 is in the clockwise direction, and the second torque caused by the weight of the mounting bracket 15 and the display 13 to the shaft 20 is in the counter-clockwise direction. The lever arm for the first torque is the shortest distance from the center of the shaft 20 to a center line of an interconnection member 56 (will be introduced below) or the mechanical spring 53 of the spring device 50. The lever arms of both the first torque and the second torque change as the shaft 20 rotates. When the display 13 reaches the highest point, the orientation of the display 13 is horizontal, and the lever arms of both the first torque and the second torque are zero. Thus, both the first torque and the second torque become zero. On the other hand, when the mounting bracket 15 and the display 13 are located on the second side 92 of the support base 17 as shown in FIG. 5, the first torque provided by the spring device 50 to the shaft 20 is in the counter-clockwise direction, and the second torque caused by the weight of the mounting bracket 15 and the display 13 to the shaft 20 is in the clockwise direction. As mentioned above, the first torque provided by the spring device 50 can allow the user to effortlessly flip the display 13, and can also make the flipped display 13 slowly rotate downwards so that the user does not have to keep holding the display 13.

As shown in FIGS. 4 and 5, in some embodiments, the bracket body 14 of the mounting bracket 15 and the connecting structure 35 of the rotation connector 30, which is used to connect the spring device 50, are located on opposite sides of the shaft 20, such that the spring device 50 including the tension spring can constantly provide the first torque that is in a direction opposite to the second torque. For example, as shown in FIG. 4, the bracket body 14 and the display 13 are located on the left side of the shaft 20, whereas the connecting structure 35 of the rotation connector 30 is located on the right side of the shaft 20. Hence, the spring device 50 connected to the connecting structure 35 can apply the first torque in a clockwise direction to the shaft 20, which is opposite to the second torque in a counterclockwise direction. On the other hand, when the bracket body 14 and the display 13 are located on the right side of the shaft 20 as shown in FIG. 5, the connecting structure 35 of the rotation connector 30 is located on the left side of the shaft 20. Hence, the spring device 50 connected to the connecting structure 35 can provide the first torque in a counterclockwise direction to the shaft 20, which is opposite to the second torque in a clockwise direction.

Please refer back to FIGS. 2 and 3. As shown in the figures, in some embodiments, the spring device 50 further includes an interconnection member 56. The interconnection member 56 is connected between the mechanical spring 53 and the connecting structure 35 of the rotation connector 30. In other words, two opposite ends of the interconnection member 56 are joined with the mechanical spring 53 and the connecting structure 35, respectively. The interconnection member 56 has a first width, and the mechanical spring 53 has a second width greater than the first width. The first width and the second width specify the width of the interconnection member 56 and the mechanical spring 53 in a direction normal to the extending direction of the interconnection member 56 and the mechanical spring 53. With this configuration, the mechanical spring 53 with greater width or diameter can be disposed at a farther position from the shaft 20, and the thickness of the rotation mechanism 19 can be reduced accordingly. The interconnection member 56 may include a rigid component. For example, in some embodiments, the interconnection member 56 is a metal linkage rod. Alternatively, the interconnection member 56 may include a non-rigid component such as a rope made of, for example, nylon or wires. In some embodiments, if the mechanical spring 53 is narrow enough in width and long enough in length, the interconnection member 56 can be omitted and the mechanical spring 53 can be directly connected to the connecting structure 35. In some embodiments, the interconnection member 56 can be integrally formed with the mechanical spring 53 in one piece.

As shown in FIGS. 2 and 3, in some embodiments, the rotation mechanism 19 further includes a rotation resistance device 29. The rotation resistance device 29 is connected to the shaft 20 and is configured to provide a frictional torque to impede rotation of the shaft 20. In some embodiments, the rotation resistance device 29 is disposed at an end of the shaft 20. For example, the rotation resistance device 29 may be coupled to the end of the shaft 20 away from the mounting bracket 15.

In some embodiments, the rotation resistance device 29 includes a damper, e.g., a fluid viscous damper. The damper can produce resistance proportional to the rotation speed of the shaft 20, which helps the display 13 decelerate or stop at any angle when the display 13 is flipped.

In some embodiments, the rotation resistance device 29 includes a friction device. The friction device may include one or more washers pressing against the shaft 20 to continuously generate frictional resistance force when the shaft 20 is rotating, and the frictional resistance force creates the frictional torque to impede rotation of the shaft 20. When the second torque caused by the weight of the display 13 is slightly greater than the sum of the frictional torque and the first torque provided by the spring device 50, the user can flip the display 13 with less effort and the display 13 would slowly rotate downward after the user stops applying force on the display 13. When the difference between the second torque and the first torque is less than or equal to the frictional torque, the display 13 can stop at any rotation angle and maintain a tilt orientation. In some embodiments, the first torque is less than or equal to the sum of the second torque and the frictional torque to prevent the display 13 from flipping back upwards.

As shown in FIGS. 2 and 3, in some embodiments, the spring fixture 60 includes a base component 61 and a movable component 65 movably disposed on the base component 61. In the illustrated embodiment, the movable component 65 can move upward or downward relative to the base component 61. The second end 52 of the spring device 50 is connected to the movable component 65, and the length of the spring device 50 changes (increases or decreases) as the position of the movable component 65 is adjusted. Therefore, the torque applied by the spring device 50 to the shaft 20 and the rotation connector 30 can be controlled by adjusting the position of the movable component 65.

In some of the embodiments, the mechanical spring 53 is a tension spring configured to apply a pulling force to the rotation connector 30. If the movable component 65 is adjusted to a lower position, the length of the mechanical spring 53 is increased and thus the torque provided by the spring device 50 increases. On the other hand, if the movable component 65 is adjusted to a higher position, the length of the mechanical spring 53 is decreased and thus the torque provided by the spring device 50 decreases.

As shown in FIGS. 2 and 3, in some embodiments, the spring fixture 60 further includes a threaded post 63 disposed on the base component 61. The movable component 65 is coupled to the threaded post 63, e.g., the movable component 65 has a threaded hole mating with the threaded post 63, and the movable component 65 is configured to move along the threaded post 63 as the threaded post 63 is rotated. Thus, by rotating the threaded post 63, the user can adjust the movable component 65 to an appropriate position and fix the movable component 65 at that position, thereby setting the appropriate torque provided by the spring device 50 to facilitate flipping of the display 13.

As shown in FIGS. 2 and 3, in some embodiments, the base component 61 of the spring fixture 60 is fixedly disposed on the support bracket 70. In some embodiments, the support bracket 70 has at least one guiding groove 74. The movable component 65 of the spring fixture 60 is disposed in the guiding groove 74 and is configured to move along the guiding groove 74.

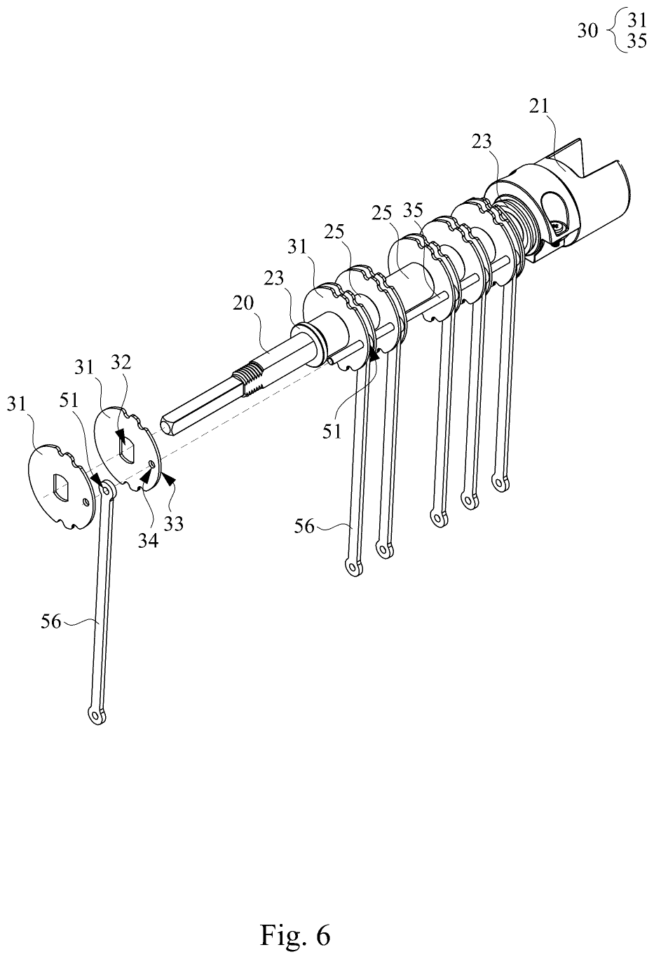

Reference is made to FIG. 6. FIG. 6 illustrates an exploded view of some components of the rotation mechanism 19 shown in FIG. 2. In some embodiments, each connector disk 31 has a central opening 32, and the shaft 20 extends through the central opening 32. The central opening 32 and the cross-section of the shaft 20 have similar shapes. Hence, the connector disk 31 can fixedly engage the shaft 20 and rotate synchronously with the shaft 20, i.e., the connector disk 31 has no freedom of rotation relative to the shaft 20. In some embodiments, the shaft 20 includes a section having a generally rectangular cross-section, and the central opening 32 of the connector disk 31 is also generally rectangular. However, the present disclosure is not limited thereto. Other shapes that can achieve a similar effect are also applicable.

As shown in FIG. 6, in some embodiments, each connector disk 31 further has an outer perimeter 33 surrounding the central opening 32. The connecting structure 35 is positioned between the central opening 32 and the outer perimeter 33 and is connected to the spring device, e.g., connected to the interconnection member 56 of the spring device. In other words, the position of the connecting structure 35 is outside the central opening 32 and inside the outer perimeter 33. A distance from the center of the shaft 20, e.g., where the axis 90 passes, to the connecting structure 35 is greater than the outer radius of the shaft 20.

As shown in FIG. 6, in some embodiments, the first end 51 of the spring device is pivotably connected to the connecting structure 35 of the rotation connector 30. By this arrangement, the spring device can pivot relative to the rotation connector 30 to facilitate extension and contraction of the mechanical spring (see the mechanical spring 53 shown in FIG. 5).

As shown in FIG. 6, in some embodiments, the rotation connector 30 includes a plurality of connector disks 31 arranged in a row, and the connecting structure 35 includes a linkage rod linking each of the connector disks 31. For example, each connector disk 31 may have a through hole in which the linkage rod can be inserted. Correspondingly, there are a plurality of spring devices connected to the connecting structure 35. Although FIG. 6 only illustrates the interconnection members 56 of the spring device, the entire structure of the spring device, including the interconnection member 56 and the mechanical spring 53, is shown in FIG. 5. The spring devices are separately arranged and are pivotably connected to the linkage rod. In one embodiment, the interconnection member 56 of the spring device also has a through hole in which the linkage rod can be inserted, such that the interconnection member 56 is pivotably connected to the linkage rod. In other embodiments, the spring devices are mutually linked. In some embodiments, in order to reduce the size of the display mounting stand, the rotation mechanism can include a single connector disk 31 and a single spring device.

It should be noted that the connecting structure 35 is not limited to the structure described above. For example, in other embodiments, the connector disk 31 can include other structures, such as a hole, a recess, a protrusion, or a hook structure, which act as the connecting structure 35 for connecting the spring device.

As shown in FIG. 6, in some embodiments, the interconnection member 56 of each spring device is sandwiched by two connector disks 31. In some embodiments, the rotation mechanism further includes at least one sleeve 25 fit over the shaft 20. The at least one sleeve 25 is located between two adjacent connector disks 31, such that the two connector disks 31 can maintain a constant distance and can be prevented from interfering with each other. In some embodiments, the sleeve 25 can be replaced by other components or structures having similar function, such as a spacer or a rivet post.

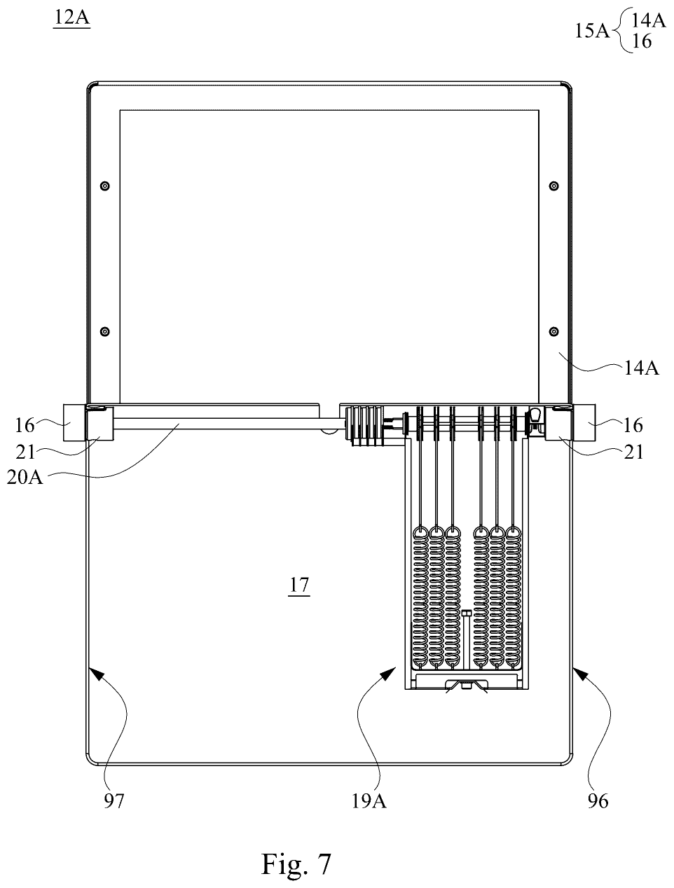

Reference is made to FIG. 7. FIG. 7 illustrates a front view of a display mounting stand 12A in accordance with another embodiment of the present disclosure. The display mounting stand 12A of the present embodiment includes a single mounting bracket 15A and a single rotation mechanism 19A, which is different from the above-mentioned embodiments. The bracket body 14A of the mounting bracket 15A extends from a first edge 96 of the support base 17 to a second edge 97 of the support base 17. The first edge 96 and the second edge 97 are located on opposite sides of the support base 17. The connection portions 16 are provided on both sides of the bracket body 14A. The bracket body 14A is, for example, a frame structure. The shaft 20A of the rotation mechanism 19A extends from the first edge 96 to the second edge 97 of the support base 17. The joint structures 21 are provided at both ends of the shaft 20A. The two joint structures 21 are joined with the two connection portions 16 of the mounting bracket 15A, respectively. By this arrangement, the display mounting stand 12A can guide the flipping of the display with a single rotation mechanism 19A.

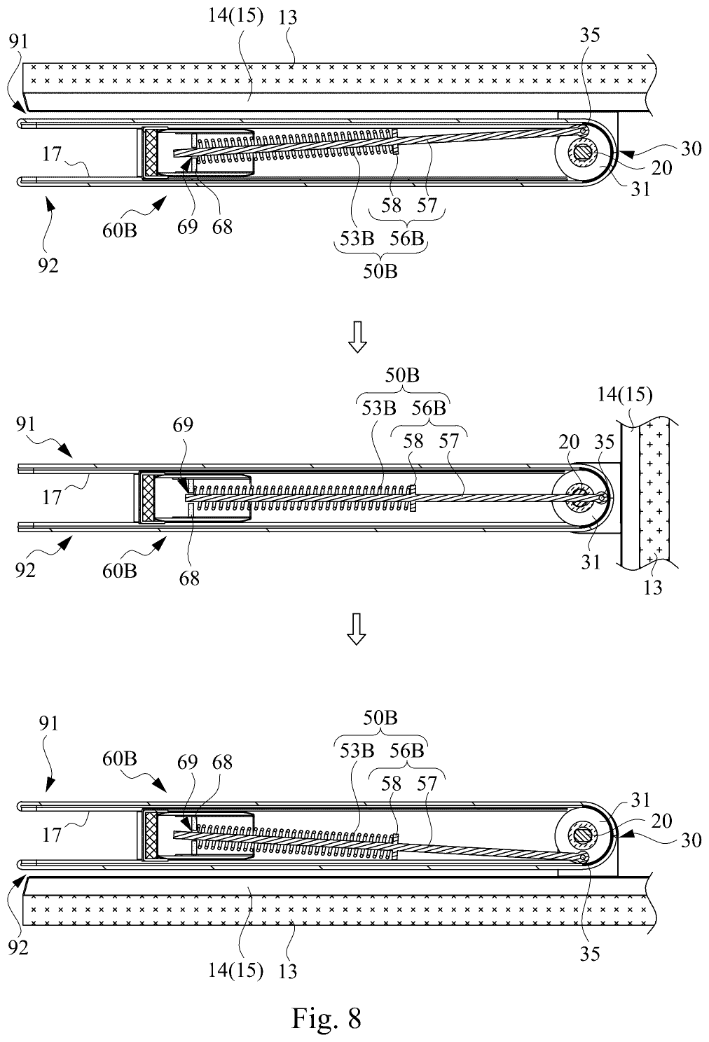

Reference is made to FIG. 8. FIG. 8 illustrates section views of a display device in accordance with another embodiment of the present disclosure, and schematically shows a process of the mounting bracket 15 and the display 13 of the display device being flipped from a first side 91 to a second side 92 of the support base 17. The present embodiment differs from the embodiments described above in that the spring device 50B includes a compression spring, i.e., the mechanical spring 53B, instead of the tension spring. The compression spring can apply torque to the rotation connector 30 through its restoring force. The direction of the torque applied by the compression spring is opposite to the direction of the torque caused by the weight of the display 13 and the mounting bracket 15. Moreover, since the compression spring replaces tension spring, the bracket body 14 of the mounting bracket 15 and the connecting structure 35 of the rotation connector 30 are located on the same side of the shaft 20.

As shown in FIG. 8, when the mounting bracket 15 and the display 13 are located on the first side 91 of the support base 17, the weight of the display 13 applies a counter-clockwise torque to the shaft 20 via the bracket body 14. Meanwhile, the connecting structure 35, which is connected to the spring device 50B, is at a position near the first side 91 of the support base 17. Thus, the compression spring can provide a clockwise torque that partially or completely counteracts the torque caused by the weight of the display 13. When the bracket body 14 of the mounting bracket 15 and the display 13 are flipped to the upper side of the connector disk 31 and the orientation of the display 13 becomes horizontal, the connecting structure 35 rotates to the upper side of the connector disk 31 and is at a position directly above the shaft 20. As a result, the torque provided by the compression spring becomes zero. When the mounting bracket 15 and the display 13 are flipped to the second side 92 of the support base 17, the connecting structure 35 rotates to a position near the second side 92 of the support base 17. Thus, the compression spring can provide a counter-clockwise torque, which is opposite to the clockwise torque caused by the weight of the display 13.

As shown in FIG. 8, in some embodiments, the interconnection member 56B of the spring device 50B includes a rod 57 and a first cap 58. The rod 57 includes a first section and a second section. The first section penetrates through the mechanical spring 53B. The second section connects the connecting structure 35 of the rotation connector 30 and the mechanical spring 53B. The first cap 58 is fixedly disposed on the middle portion of the rod 57 and divides the rod 57 into the first section and the second section. The first cap 58 is configured to press against an upper end of the compression spring, i.e., the mechanical spring 53B. The first cap 58 moves as the rotation connector 30 rotates, which changes the length and the elastic force of the compression spring. Meanwhile, the first section of the rod 57 penetrating through the mechanical spring 53 can prevent the compression spring from buckling and becoming unable to provide sufficient elastic force. In some embodiments, a width of the first cap 58 is greater than a width of the mechanical spring 53B. In some embodiments, a width of the second section is greater than a width of the mechanical spring 53B and the first cap 58 may be omitted. In some embodiments, a width of the second section of the rod 57 is less than the width of the mechanical spring 53B.

As shown in FIG. 8, in some embodiments, the spring fixture 60B includes a second cap 68. The second cap 68 is fixed and configured to press against a lower end of the compression spring. In some embodiments, the second cap 68 has a through hole 69. The rod 57 is a rigid structure with fixed length. A lower end of the rod 57 moveably penetrates the through hole 69 of the second cap 68. When the connecting structure 35 rotates to the left side or the right side of the shaft 20, the lower end of the rod 57 can pass through the through hole 69 of the second cap 68 and partially extend to the underside of the second cap 68. For example, the portion of the rod 57 extending to the underside of the second cap 68 has a first length which is greater than zero. When the connecting structure 35 rotates to the upper side of the shaft 20, the portion of the rod 57 extending to the underside of the second cap 68 has a second length less than the first length. The second length can be greater than zero or equal to zero. For example, the rod 57 may extend into, but not out of, the through hole 69 of the second cap 68. In some embodiments, the second cap 68 is not fixed but movable relative to the base component of the spring fixture 60B, which allows the user to adjust the preset compression of the mechanical spring 53B.

In summary, the display mounting stand of the present disclosure includes a rotation mechanism, which includes a shaft, a rotation connector and a spring device. The rotation connector is fixed to the shaft and is configured to rotate with the shaft. Moreover, the rotation connector includes a connecting structure spaced apart from the shaft. The spring device is connected to the connecting structure of the rotation connector and thus can apply torque to the shaft. The mounting stand further includes a mounting bracket connected to the shaft and configured to support a display. By this arrangement, when the mounting bracket and the display are flipped, the spring device applies torque to the rotation connector and the shaft to guide the rotation of the mounting bracket and the display. And as the orientation of the mounting bracket and the display changes, the torque applied by the spring device changes its direction and magnitude, which allows the user to easily flip the display. In addition, once the user stops applying force to the display, the display can automatically decelerate as it rotates downward, or can stop and remain at any angle.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A display mounting stand, comprising:
a support base;
at least one rotation mechanism disposed on at least one side of the support base; and
at least one mounting bracket connected to the at least one rotation mechanism on the at least one side of the support base;
wherein the at least one rotation mechanism comprises:
a shaft rotatably disposed on the support base and connected to the at least one mounting bracket on the at least one side of the support base;
a rotation connector fixed on the shaft and configured to rotate with the shaft, the rotation connector comprising at least one connecting structure spaced apart from the shaft;
at least one spring device having a first end and a second end opposite to the first end, the first end being connected to the at least one connecting structure of the rotation connector; and
a spring fixture connecting and fixing the second end of the at least one spring device;
wherein the at least one mounting bracket is configured to mount a display and the shaft rotates with the at least one mounting bracket, the at least one spring device is configured to apply a first torque to the shaft, the at least one mounting bracket is configured to apply a second torque caused by weight of the display to the shaft, and the first torque and the second torque are in opposite directions.

2. The display mounting stand of claim 1, wherein the first end of the at least one spring device is pivotably connected to the at least one connecting structure of the rotation connector.

3. The display mounting stand of claim 1, wherein the rotation connector comprises at least one connector disk, the at least one connector disk has a central opening and an outer perimeter, the shaft extends through the central opening, the outer perimeter surrounds the central opening, the at least one connecting structure is positioned between the central opening and the outer perimeter.

4. The display mounting stand of claim 1, wherein the rotation connector comprises a plurality of connector disks arranged in a row and a linkage rod linking the connector disks, and the at least one spring device is pivotably connected to the linkage rod.

5. The display mounting stand of claim 1, wherein the at least one spring device comprises a mechanical spring and an interconnection member, the interconnection member comprises a section between the mechanical spring and the rotation connector, the section of the interconnection member has a first width, and the mechanical spring has a second width greater than the first width.

6. The display mounting stand of claim 1, wherein lever arms of the first torque and the second torque are zero when the display mounted on the at least one mounting bracket is rotated to a horizontal orientation.

7. The display mounting stand of claim 1, wherein the at least one mounting bracket comprises a bracket body and a connection portion, the connection portion connects the bracket body to an end of the shaft on the at least one side of the support base.

8. The display mounting stand of claim 1, wherein the at least one spring device comprises a tension spring, and the display mounted on the at least one mounting bracket and the at least one connecting structure of the rotation connector are located on opposite sides of the shaft.

9. The display mounting stand of claim 1, wherein the at least one spring device comprises a compression spring, and the display mounted on the at least one mounting bracket and the at least one connecting structure of the rotation connector are located on same side of the shaft.

10. The display mounting stand of claim 9, wherein the at least one spring device further comprises an interconnection member, the interconnection member comprises a rod and a first cap, the first cap is fixedly disposed on the rod and divides the rod into a first section and a second section, the first section penetrates through the compression spring, the second section is connected to the at least one connecting structure of the rotation connector, wherein the compression spring is compressed between the first cap and the spring fixture.

11. The display mounting stand of claim 10, wherein the spring fixture comprises a second cap having a through hole, the second cap presses against a lower end of the compression spring, and a lower end of the rod moveably penetrates the through hole of the second cap.

12. The display mounting stand of claim 1, wherein the at least one rotation mechanism further comprises a rotation resistance device connected to the shaft and configured to provide a frictional torque to impede rotation of the shaft.

13. The display mounting stand of claim 1, wherein the spring fixture comprises a movable component, the at least one spring device is connected to the movable component, and a length of the at least one spring device changes as a position of the movable component is adjusted.

14. A display device, comprising:
a display; and
a display mounting stand, comprising:
a support base;
a rotation mechanism disposed on the support base; and
a mounting bracket connected to the rotation mechanism on the support base, wherein the display is mounted on the mounting bracket;
wherein the rotation mechanism comprises:
a shaft rotatably disposed on the support base and connected to the mounting bracket, wherein the shaft rotates with the mounting bracket;
a rotation connector fixed on the shaft and configured to rotate with the shaft, the rotation connector comprising a connecting structure spaced apart from the shaft;
at least one spring device having a first end and a second end opposite to the first end, the first end being connected to the connecting structure of the rotation connector; and
a spring fixture connecting and fixing the second end of the at least one spring device;
wherein the at least one spring device is configured to apply a first torque to the shaft, the mounting bracket is configured to apply a second torque caused by weight of the display to the shaft, the first torque and the second torque are in opposite directions.

15. The display device of claim 14, wherein the first end of the at least one spring device is pivotably connected to the connecting structure of the rotation connector.

16. The display device of claim 14, wherein the mounting bracket comprises a bracket body and a connection portion, the connection portion connects the bracket body to an end of the shaft, wherein the at least one spring device comprises a tension spring, and the display mounted on the mounting bracket and the connecting structure of the rotation connector are located on opposite sides of the shaft.

17. The display device of claim 14, wherein the mounting bracket comprises a bracket body and a connection portion, the connection portion connects the bracket body to an end of the shaft, wherein the at least one spring device comprises a compression spring, and the display mounted on the mounting bracket and the connecting structure of the rotation connector are located on same side of the shaft.

18. The display device of claim 14, wherein lever arms of the first torque and the second torque are zero when the display mounted on the mounting bracket is rotated to a horizontal orientation.

19. The display device of claim 14, wherein the rotation connector comprises at least one connector disk, the at least one connector disk has a central opening and an outer perimeter, the shaft extends through the central opening, the outer perimeter surrounds the central opening, the connecting structure is positioned between the central opening and the outer perimeter.

20. The display device of claim 14, wherein the rotation connector comprises a plurality of connector disks arranged in a row and a linkage rod linking the connector disks, and the at least one spring device is pivotably connected to the linkage rod.
